(19) United States
(12) Patent Application Publication
(10) Pub. No.: US 2021/0102091 A1
(43) Pub. Date: Apr. 8, 2021

(54) Aqueous sol gel composition as a storage-stable precursor for zinc powder paints

(71) Applicant: Evonik Operations GmbH, Essen (DE)

(72) Inventors: Philipp ALBERT, Rheinfelden (DE); Dennis Bringmann, Efringen-Kirchen (DE); Julia Kirberg, Rheinfelden (DE); Eckhard Just, Rheinfelden (DE)

(73) Assignee: Evonik Operations GmbH, Essen (DE)

(21) Appl. No.: 16/608,316

(22) PCT Filed: Apr. 24, 2018
(86) PCT No.: PCT/EP2018/060420

§ 371 Date: Oct. 25, 2019

(30) Foreign Application Priority Data
May 3, 2017 (EP) 17169300.5

(51) Int. Cl. C09D 183/08; C09D 183/06; C09D 7/61; C08K 3/36; C09D 5/10; C08K 3/08; C08K 3/16

(52) U.S. Cl. CPC C09D 183/08; C09D 183/06; C09D 7/61; C08K 3/36; C08K 2003/168; C08K 3/08; C08K 3/16; C08K 2003/0893; C08K 2003/166; C09D 5/106

(57) ABSTRACT

An aqueous sol gel composition is useful as a storage-stable, solvent-free precursor for zinc powder paints. The composition is based on the reaction of at least the components (i) a glycidyloxypropyl alkoxysilane of the general formula (I) X—Si(OR)₃ (I), where X represents a 3-glycidyloxypropyl group and R represents a methyl or ethyl group, (ii) an aqueous silica sol with an average particle size ranging from 5 to 150 nm and a solids content of ≥45 to ≤55 wt. %, (iii) at least one acid selected from nitric acid, sulfuric acid, hydrochloric acid, phosphoric acid, formic acid, and acetic acid, and (iv) a his-amino silane of the general formula (II) (R¹O)₃Si(CH₂)₃(NH)(CH₂)₃Si(OR¹)₃ (II), where R¹ is a methyl or ethyl group, and optionally (v) at least one additional alkoxysilane of the general formula (III) Yₙ—Si(OR³)₄₋ₙ (I), where Y represents a propyl-, butyl-, octyl-, 3-mercaptopropyl-, 3-ureidopropyl-, or 3-isocyanatopropyl group, R³ represents a methyl or ethyl group, and n equals 0 or 1, wherein it is assumed that a mass ratio of (ii) to (i) ranges from 0.55 to 0.75 and a mass ratio of (ii) to (iv) ranges from 0.35 to 0.55. The composition also contains at least one particulate filler from precipitated silica acid, pyrogenic silica acid, crystalline silica, kaolin, feldspar, talcum, zinc oxide, iron(III) oxide, aluminum oxide, and titanium dioxide in a proportion of 5 to 70 wt. %, based on the composition.

The present invention relates to an aqueous sol-gel composition as storage-stable precursor, especially for zinc dust paints, to a process for production thereof and to the use thereof.

Zinc dust paints are used in corrosion protection in order to protect iron and steel from corrosion. Bridge constructions of steel, electricity pylons and pipelines are just a few illustrative uses. They are applied on site in that the old coating is removed and the steel is cleaned, for example by sandblasting. Subsequently, the zinc dust paint is sprayed on at the construction site. Mixtures that are complicated to handle are practically unsuitable for such a use on site, or are deprecated by professionals, since errors can always occur in the case of multicomponent systems. For instance, the required fillers and additions have to be weighed on site and stirred into the binder formulation; lastly, zinc powder is stirred in. After incorporation of the fillers, the known systems are not storage-stable for a long period, and the binder formulation not for a particularly long period, and have to be processed promptly after production. For this reason, zinc dust paints which, if possible, can be provided without any great care and without any great inconvenience on site, are required.

Binders based on silicic esters have long been known and are supplied as solvent-containing formulations with zinc dust. Typical solvent-containing, two-component systems consist of the binder as component 1 and the fillers as component 2. These solvent-containing binders are produced both as one-component formulations and as two-component formulations. According to the application, the fillers are composed of very many different components and have to be mixed at the factory. Separations can occur in the course of storage and transport. Moreover, it is a drawback of these systems that they contain solvents and release them; thus, there is a great interest in replacing systems of this kind with aqueous formulations.

There are also already aqueous zinc dust paints that contain silanes. However, it has not yet been possible to date to produce a stable and storable and aqueous precursor for zinc dust paint, i.e. a stable and storable and aqueous binder system including fillers but at first still without added zinc powder, since zinc also acts as a catalyst in the hardening of the systems.

EP1191075 discloses a water-based two-component system for anticorrosion coatings on steel. The first component comprises water, an aminoalkyltrialkoxysilane, an acid, an epoxysilane and conductive pigments or fillers. The second component consists of zinc powder. The finished mixture is said to enable a processing time of 16 hours. The alcohol from the hydrolysis of the silane has not been removed.

WO2006/079516 relates to an aqueous binder composition consisting of an epoxysilane, a formylaminopropyltrialkoxysilane and a tetraalkoxysilane. What is claimed here is a two-component system consisting of the binder as component 1 and the filler, as component 2.

WO2012/130544 also describes the production and composition of an aqueous zinc dust paint.

The production of water-soluble aminopolysiloxanes is described in EP0590270. The aminosilanes are admixed in a 50% alcoholic solution with an appropriate amount of water and partly hydrolysed at 60° C. These products are subsequently soluble in water. A drawback continues to be the high content of organic solvents and the associated low flashpoint.

DE10335178 likewise describes the production of water-soluble silane systems, for example a mixture of 3-aminopropyltrialkoxysilane and bis(trialkoxysilylpropyl)amine. The silane mixture is partly hydrolysed with a defined amount of water. But here too, the silane mixture contains 25% to 99.99% alcohol and is thus not VOC-free.

U.S. Pat. No. 5,051,129 claims the composition of an aqueous solution consisting of a water-soluble aminosilane and an alkyltrialkoxysilane. It is produced by addition of a defined amount of water to the silane mixture and subsequent heat treatment at 60° C. The silane mixture thus produced is dissolved in water in a particular ratio and serves for hydrophobization of surfaces.

EP0716128 claims water-based organopolysiloxane-containing compositions, processes for production thereof and use. Mixing of water-soluble aminoalkylalkoxysilanes with alkyltrialkoxysilanes and/or dialkyldialkoxysilanes and addition of water at a defined pH gives rise to organopolysiloxane-containing compositions. The alcohol of hydrolysis formed is removed by distillation. Therefore, VOC-free aqueous polysiloxane-containing compositions are obtained, which can be used for hydrophobization of surfaces, mineral building materials and further applications.

WO2000/39177 describes the use of bissilyaminosilanes and/or bissilylpolysulfanes in aqueous solutions. The silanes are mixed with water, an alcohol and optionally acetic acid and hydrolysed for at least 24 h. This is followed by application to metals.

U.S. Pat. No. 6,955,728 describes the use of acetoxysilanes in combination with other silanes in aqueous solutions and application to metals. Bis(trialkoxysilylpropyl)amines are among the substances used in combination with acetoxysilanes. No statement is made as to the stability of the aqueous solutions; a 2-component system is recommended, which is only combined prior to application. The aqueous solutions at least always contain the alcohol of hydrolysis.

In WO2004/076717, bissilylaminosilanes are used in combination with further silanes and a metal chelate in aqueous solutions. The silanes are partly hydrolysed by ageing for at least 2 weeks in aqueous concentrates.

Subsequently, a metal chelate is added and the mixture is diluted further with water. Furthermore, it is still the case that all aqueous formulations contain the alcohol from the hydrolysis. The aqueous systems are used for pretreatment of metal surfaces.

WO2004/076718 relates to a process for coating a metallic surface with an aqueous solution containing a partially hydrolysed silane, for example bissilylaminosilane, and a partially hydroysed fluorine-containing silane.

The use of the fluorine-containing silane improves the hydrophobicity and corrosion resistance of the coating system. The alcohol of hydrolysis is not removed from the systems.

U.S. Pat. No. 5,206,285 describes the production and use of water-based addition products formed from an epoxysilane and an aminosilane. The aqueous silane systems are not solvent-free. They are used for metal coating and are intended to improve the corrosion resistance.

EP1760128 teaches an aqueous two-component adhesion promoter composition and the use thereof for bonding or sealing. One component of the adhesion promoter may comprise a bissilylaminosilane.

DE102004037045 claims aqueous silane nanocomposites which are prepared from glycidyloxypropylalkoxysilanes and aqueous silica sols in the presence of a catalyst. The aqueous systems are virtually solvent-free and are suitable for metal coatings. A disadvantage is the high crosslinking temperatures of 200° C.

U.S. Pat. No. 6,468,336 describes the formulation and application of an anticorrosion coating for steel. The water-based formulation contains, as binder, waterglass and, as pigments, zinc, iron sheet silicates and further fillers. The formulations described are said to achieve excellent corrosion protection in layer thicknesses of 15 to 25 μm.

WO2000/46311 describes the treatment of metal substrates with a formulation composed of a ureidosilane, a multisilyl silane and a solvent. The silanes are first partly hydrolysed and then formulated. The alcohol of hydrolysis is not removed and the formulation is used without pigments.

WO02002/22745 claims a solvent-free anticorrosion primer. The primer is composed of a stabilized silica sol, a sheet silicate, a calcined aluminium sheet silicate and zinc dust. The dry layer thickness of the coating is about 15-25 μm. The abrasion resistance and processing time were determined.

WO2003/22940 claims an anticorrosion system consisting of an aqueous silica sol, optionally an organic resin, zinc dust and further additives. The systems are characterized by the abrasion resistance and pencil hardness.

WO99/14277 describes an aqueous primer composition consisting of a reactive resin (dispersion), an organofunctional silane (amino- or epoxysilane, no bissilylsilanes) and a hardening reagent. Bonds of metal substrates that have been treated with this primer, in combination with an epoxy resin, show very good strengths in a shear test.

WO2008/133916 describes a method of treating metal surfaces. The method includes treatment with an aqueous formulation consisting of hydrolysed/condensed silanes. The silanes used may be aminosilanes containing hydroxyl groups. The coating systems thus produced are not solvent-free. The metal substrates treated were painted and, by comparison with the standard treatment, show lower creepage from the scribe.

U.S. Pat. No. 6,929,826 claims a method for surface treatment of metals. The method includes treatment with a formulation comprising an epoxysilane and a tetraalkoxysilane.

WO2006/137663 describes a composition consisting of an aminosilane and an epoxysilane. In addition, the formulation comprises a magnesium and vanadium compound and an acid. It is produced in a water/alcohol mixture. The metal substrates treated with this formulation show good corrosion resistance and good adhesion to organic coatings. The systems are not solvent-free.

WO2009/059798 claims a formulation and coating for a metal. The formulation consists of tetraethoxysilane, vinyltrimethoxysilane, phenytriethoxysilane, and propyltrimethoxysilane. Additionally claimed are further components such as alcohols, catalysts, silica sols and additives. The coatings of the invention have to be heated for hardening. The formulation is intended to protect metal substrates from corrosion.

EP 0274428 claims a composition consisting of an alkyltrialkoxysilane, a vinyltrialkoxysilane and/or further silanes such as an epoxysilane, an organic solvent and an aluminium sol.

WO2009/030538 teaches aqueous compositions based on bisalkoxyalkylsilylamines that are essentially free of organic solvents and do not release any alcohol even in the course of crosslinking. In addition, systems of this kind may be based on further organosilanes such as 3-glycidyloxypropyltrialkoxysilanes and alkylalkoxysilanes, and comprise fillers such as silica, titanium dioxide and aluminium oxide, and also colour pigments. Additionally disclosed are the process for production and use—as an anticorrosion coating among other uses.

On the part of the user, there is therefore a great interest in being able to prepare and use aqueous zinc dust paints on site in a very simple manner at the construction site.

The problem addressed by the present invention was thus that of providing a largely solvent-free water-based precursor with maximum storage stability for improved and simpler formulation of a zinc dust paint prior to application thereof. Another particular aim was to minimize sources of error in the mixing and application of zinc dust paints on site without reducing the actual mode of action of the zinc dust paint [also called application formulation or composition hereinafter].

The problem was solved in accordance with the invention in accordance with the features in the claims.

It is pointed out explicitly that, in the present invention, “solvent-free” means that a composition according to the invention does not contain any organic solvents, although methanol and ethanol in an amount of <3% by weight, based on the composition, should not be considered here within the meaning of an organic solvent and should thus be excluded.

It has surprisingly been possible to provide an aqueous, already filler-containing solgel composition which is essentially solvent-free and is storage-stable even under severe storage conditions, corresponding to long-term storage, for 4 months at 50° C., A sol-gel composition of this kind is advantageously based on a specific reaction product of the following components:
(i) a glycidyloxypropylalkoxysilane of the general formula (I)

X—Si(OR)₃ (I)
in which X is a 3-glycidyloxypropyl group and R is a methyl or ethyl group,
(ii) an aqueous silica sol having an average particle size of 5 to 150 nm and a solids content [dry residue] of ≥20% to ≤60% by weight, preferably of ≥30% to ≤55% by weight, more preferably ≥45% to ≤50% by weight,
(iii) at least one acid selected from the group of nitric acid, sulfuric acid, hydrochloric acid, phosphoric acid, formic acid, acetic acid and
(iv) a bisaminoalkoxysilane of the general formula (i)

(R¹O)₃Si(CH₂)₃(NH)(CH₂)₃Si(OR¹)₃ (II)
in which R¹ represents a methyl or ethyl group,
and optionally
(v) at least one further alkoxysilane of the general formula (III)

Yₙ—Si(OR³)₄₋ₙ (I)
in which Y represents a propyl, butyl, octyl, 3-mercaptopropyl, 3-ureidopropyl or 3-isocyanatopropyl group, R³ is a methyl or ethyl group and n is 0 or 1,
wherein an initial mass ratio of component (i) to component (i) of 0.55 to 0.75 and an initial mass ratio of component (ii) to component (v) of 0.35 to 0.55 is used,
preferably a mass ratio of component (i) to component (i) of 0.60 to 0.70 and a mass ratio of component (ii) to component (iv) of 0.40 to 0.50,
and
(vi) at least one particulate filler from the group of precipitated silica, fumed silica, crystalline silica, kaolin, feldspar, talc, zinc oxide, iron(III) oxide, aluminium oxide, titanium dioxide having a content of 5% to 70% by weight, based on the composition,
wherein the silane condensates and/or cocondensates present in the present sol-gel composition are in virtually fully hydrolysed form and the sol-gel composition advantageously has a content of alcohol of <3% by weight, especially alcohol of hydrolysis, such as methanol and ethanol, preferably of 05% to 2.5% by weight, based on the overall composition, and a pH of 3.0 to 6.5, preferably 3.5 to 6, more preferably 4 to 5.5, especially 4.0 to 5.0.

Thus, a present sol-gel composition can be classified not just as solvent-free but also as low in VOCs (VOCs=volatile organic compounds). The viscosity and pH of a present sol-gel composition also remain virtually unchanged after storage.

More particularly, the advantage of a present sol-gel composition is that, even after prolonged storage, without further additions of filler, it merely has to be mixed with zinc dust on site for application, and hence handling on site can be distinctly simplified and therefore distinctly improved.

Use properties of such a zinc dust paint with regard to anticorrosion properties also remain advantageous to a virtually unchanged degree after storage.

Furthermore, it has been found that, in the formulation of the zinc dust paint proceeding from a present sol-gel composition, by addition of ZnCl₂ and/or MgCl₂ or other chlorides as well as zinc powder, even quicker hardening of the Zn-containing application composition (zinc dust paint) can additionally be achieved.

The present invention therefore provides an aqueous sol-gel composition [also referred to hereinafter as composition for short] as a storage-stable, solvent-free precursor for zinc dust paints, based on the reaction at least of the following components:
(i) a glycidyloxypropylalkoxysilane of the general formula (I)

X—Si(OR)₃ (I)
in which X is a 3-glycidyloxypropyl group and R is a methyl or ethyl group,
(ii) an aqueous silica sol having an average particle size of 5 to 150 nm and a solids content [dry residue] of ≥20% to ≤60% by weight,
(iii) at least one acid selected from the group of nitric acid, sulfuric acid, hydrochloric acid, phosphoric acid, formic acid, acetic acid and
(iv) a bisaminoalkoxysilane of the general formula (II)

(R¹O)₃Si(CH₂)₃(NH)(CH₂)₃Si(OR¹)₃ (II)
in which R¹ represents a methyl or ethyl group, and optionally
(v) at least one further alkoxysilane of the general formula (III)

Yₙ—Si(OR³)₄₋ₙ (I)
in which Y represents a propyl, butyl, octyl, 3-mercaptopropyl, 3-ureidopropyl or 3-isocyanatopropyl group, R³ is a methyl or ethyl group and n is 0 or 1,
wherein an initial mass ratio of component (i) to component (i) of 0.55 to 0.75 and an initial mass ratio of component (ii) to component (iv) of 0.35 to 0.55 is used,
   and containing
   (vi) at least one particulate filler from the group of precipitated silica, fumed silica, crystalline silica, kaolin, feldspar, talc, zinc oxide, iron(III) oxide, aluminium oxide, titanium dioxide having a content of 5% to 70% by weight, based on the composition,
   wherein the storage-stable aqueous sol-gel composition has a content of alcohol of <3% by weight, based on the overall composition, and a pH of 3.0 to 6.5.

Particularly advantageously, a composition of the invention is based on an aqueous silica sol as component (i) having a pH of 8.5 to 10.5, i.e. an aqueous basic silica sol.

More particularly, it is a feature of an aqueous silica sol as component (i) that the amorphous silica particles present therein have an average diameter of ≥5 to 150 nm, more preferably 8 to 130 nm, especially 15 to 80 nm.

Useful fillers as per component (v) are found to be, for example—but not exclusively—Mica MKT having an average particle size d₅₀ of 4.5 μm, Miox Micro 30 with da of 30 μm, talc with d₅₀ of 4 to 10 μm, Sikron M500 with do of 3.0 μm, TiO₂ with a crystal size in the region of 220 nm, ZnO of particle size from 20 nm to 10 μm, and Bayferrox Red iron oxide with a predominant particle size of 0.17 μm.

The present invention further provides a process for producing a sol-gel composition of the invention by
initially charging water and acid as per component (ii), suitably in well-defined amounts,
under an inert gas atmosphere and while stirring, metering in the aqueous silica sol as per component (i) and then the glycidyloxypropylalkoxysilane of the formula (I) as per component (i), heating while stirring, and
subsequently metering in bisaminoalkoxysilane of the formula (II) as per component (iv) and once or more than once metering in acid as per component (ii) and optionally metering in at least one further alkoxysilane of the formula (III) as per component (v) while stirring, allowing reaction to continue for a further period,
then removing the alcohol of hydrolysis that has formed by distillation, optionally adding water, cooling to room temperature and then filtering the reaction product and stirring at least one particulate filler as per component (vi) into the filtrate thus obtained and optionally establishing a pH of 3.0 to 6.5 with addition of acid as per component (ii).

In the performance of the process according to the invention, the metered addition of components (ii) and (i) is preferably followed by stirring over a period of 30 to 90 minutes and heating to a temperature in the range from 50 to 70° C.

It is further preferable, in the performance of the process according to the invention, for the metered addition of components (iv) and optionally (v) to be followed by stirring over a period of 30 to 300 minutes and continued reaction at a temperature in the range from 50 to 70° C.

It is likewise preferable, in the performance of the process according to the invention, for the alcohol of hydrolysis formed in the reaction, methanol and/or ethanol to be removed from the system under reduced pressure and for the amount of alcohol removed to be optionally replaced by a corresponding amount of water.

After the distillative removal of the alcohol of hydrolysis, the reaction product can be cooled down to room temperature and then filtered through a paint filter in order to remove any turbidity that has arisen.

In the process according to the invention, at least one particulate filler from the group of precipitated silica, fumed silica, crystalline silica, kaolin, feldspar, talc, which is also referred to as steatite, soapstone or magnesium silicate, zinc oxide, iron(III) oxide, aluminium oxide, titanium dioxide is dispersed into a reaction product obtained correspondingly or into the filtrate and establishes a filler content of 5% to 70% by weight, based on the composition.

In general, a sol-gel composition of the invention is produced as follows:

An apparatus comprising, for example, reaction flask, metering unit, stirring apparatus, reflux condenser, heating/cooling apparatus and distillation apparatus is suitably first purged with an inert gas, for example nitrogen. In general, water and acid as per component (iii) are initially charged in the reaction vessel in defined amounts. Under inert gas atmosphere and while stirring, the aqueous silica sol as per component (ii) and then the glycidyloxypropylalkoxysilane of the formula (I) as per component (i) are metered into the initial charge, the mixture is heated while stirring and subsequently bisaminoalkoxysilane of the formula (II) as per component (iv) and, once or more than once, acid as per component (iii) and optionally at least one further alkoxysilane of the formula (III) as per component (v) are metered in while stirring, and the reaction mixture is allowed to continue to react. Condensates and/or cocondensates formed from the feedstocks including silica sol, especially the alkoxysilanes used (also called silanes for short), are advantageously in fully hydrolysed form. Subsequently, the alcohol of hydrolysis formed is removed by distillation from the reaction product; water can optionally be added here. After the product remaining in the flask after the distillation has been cooled down to room temperature, the reaction product—if required, i.e. if cloudy substances are present—can be filtered and at least one particulate filler as per component (vi) can be stirred into the resultant filtrate. In addition, after checking of the pH in the composition present, it can be adjusted to a pH of 3.0 to 6.5 with addition of acid as per component (iii). In the process according to the invention, it is possible to use at least one acid from the group of nitric acid, sulfuric acid, hydrochloric acid (HCl), phosphoric acid, formic acid and acetic acid; alternatively, it is advantageously possible to use two or more different acids from those mentioned for production of a so-gel composition according to the invention, for example—but not exclusively—one organic and one inorganic acid.

The present invention thus likewise provides an essentially solvent-free, aqueous sol-gel composition obtainable by the process according to the invention, or which can advantageously be obtained by the process according to the invention.

The present invention further provides for the advantageous use of an aqueous solgel composition according to any of the claims of the invention, by dispersing zinc particles [also called zinc dust for short] into the aqueous, storage-stable solgel composition, wherein the zinc particles have an average particle size of 3 μm to 90 μm and serve as catalyst for the hardening of the dispersion, and the dispersion thus obtained is used as anticorrosion composition or as additive in anticorrosion compositions or in varnishes or in paints. More particularly, it is advantageously possible to use an aqueous sol-gel composition according to the invention as a storage-stable precursor for zinc dust paints.

In the formulation of a zinc dust paint, preference is given to using zinc particles having a size of 3 μm to 40 μm, more preferably of 3 to 14 μm, especially of 3 to 7 μm. Typically, in the case of thin coatings, smaller particles are indeed used, and a corresponding dry film thickness is, for example, in the region of 20 μm.

It is additionally advantageous when, in the formulation of the zinc dust paint, zinc chloride, for example in the form of zinc chloride powder or in the form of a zinc dust/zinc chloride powder mixture or in the form of an aqueous zinc chloride solution, is additionally added to the aqueous sol-gel composition as well as zinc dust (also called zinc powder), since a system of this kind hardens more quickly and better once again than a two-component system composed of an aqueous so-gel composition and zinc powder; it is also possible to add chloride, e.g. MgCl₂ or hydrochloric acid (HCl).

The examples which follow are intended to illustrate the invention in detail without restricting it.

### EXAMPLES

Starting materials and abbreviations used:

| Trade name | Description | Manufacturer |
|---|---|---|
| Dynasylan ® GLYMO | 3-glycidyloxypropyltrimethoxysilane (GLYMO) | Evonik Degussa |
| Dynasylan ® 1122 | bis(triethoxysilylpropyl)amine (Bis-AMEO) | Evonik Degussa |
| Dynasylan ® AMEO | 3-aminopropyltriethoxysilane (AMEO) | Evonik Degussa |
| Dynasylan ® PTMO | propyltrimethoxysilane (PTMO) | Evonik Degussa |
| Dynasylan ® MTMO | 3-mercaptopropyltrimethoxysilane | Evonik Degussa |
| Dynasylan ® 2201 EQ | 3-ureidopropyltriethoxysilane in methanol | Evonik Degussa |
| Si 264 | 3-isocyanatopropyltriethoxysilane | Evonik Degussa |
| Dynasylan ® A | tetraethoxysilane | Evonik Degussa |
| Koestrosol ® 3550 | silica sol, 35 nm | Chemische Werke Bad |
| | | Köstritz |
| HP 1535 | silica sol, 15 nm | Silco International, USA |
| SI 5540 | silica sol, 130 nm | Silco International, USA |

pH Determination:

The pH of the reaction mixtures was determined by means of a pH paper (Special indicator pH 2.5-4.5, Merck; pH-Fix 0.0-6.0, Machery-Nagel)

Determination of the Dry Residue (Solids Content):

The solids content (also referred to as dry residue) of the aqueous silane systems was determined as follows: 1 g of the sample was weighed into a small porcelain dish and dried to constant weight in a drying cabinet at 105° C.

Determination of the SiO₂ Content:

To 1.0 to 5.0 g of the sample in a 400 ml beaker were added a Kjeldahl tablet and 20 ml of sulfuric acid, and the mixture was first heated gradually. During this period, the beaker was covered with a watchglass. The temperature was increased until the sulfuric acid fumed significantly and all the organic constituents had been destroyed and the solution remained clear and light-coloured. The cold digestion solution was diluted to about 200 ml with distilled water and boiled briefly (allowing water to flow under the acid at the edge of the beaker). The residue was filtered through a white band filter and washed with hot water until the wash water indicated a pH of >4 (pH paper). The filter was dried in a platinum crucible, converted to ash and calcined in a muffle furnace at 800° C. for 1 hour. After weighing, the residue was fumed off with hydrofluoric acid, the crucible was heated until red-hot by means of a fan burner and optionally calcined once again at 800° C., cooled down and then weighed. The difference between the two weighings corresponded to the content of SiO₂.

Evaluation: D×100/E=% by weight of SiO₂

D=difference in weight before and after hydrofluoric acid fuming in mg

100=conversion to %

E=starting weight in mg

Determination of the Free Methanol and Ethanol Content:

The alcohol determination was conducted by means of GC:

Column: RTX 200 (60 m)

Temperature program: 90-10-25-240-0

Detector: FID

Injection volume: 1.0 μl

Internal standard: 2-butanol

### Example 1

A 2 l stirred apparatus with metering apparatus and reflux condenser under a nitrogen atmosphere was initially charged with 954.9 g of water and 2.16 g of formic acid (HCOOH=85% by weight), 392 g of HP 1535 and then 210.8 g of GLYMO were metered in (pH after the addition=3.0), and the mixture was heated to 65° C. and stirred for 1 hour. 11.79 g of formic acid (HCOOH=85% by weight) were added, and 90 g of bis-AMEO were metered in via the metering apparatus. It was still necessary to add a total of 2.58 g of formic acid (HCOOH=85% by weight) in order to reach pH 4.0. Thereafter, stirring was continued at 65° C. for another 3 hours. Finally, 291.96 g of alcohol/water mixture were removed by distillation at about 160 mbar. 12.23 g of water and 1.04 g of formic acid (HCOOH=85% by weight) were added to the mixture. The residue that had been cooled down to room temperature was filtered through a paint filter. The final weight of the residue was 1359.80 g.

A pale yellow milky/cloudy liquid having a pH of 4.2 was obtained.

The product is storage-stable for at least 6 months.

Dry residue: 25.8% by weight

SiO₂ content: 15.6% by weight

Free methanol: 1.5% by weight

Free ethanol: 0.7% by weight

### Example 2

A 2 l stirred apparatus with metering apparatus and reflux condenser under a nitrogen atmosphere was initially charged with 501.8 g of water and 1.5 g of formic acid (HCOOH=85% by weight). 171.6 g of HP 5540 and then 105.7 g of GLYMO were metered in (pH after the addition=2.0), and the mixture was heated to 65° C. and stirred for 1 hour. 5.88 g of formic acid (HCOOH=85% by weight) were added, and 44.45 g of Dynasyan® 1122 were metered in via the metering apparatus. It was still necessary to add 0.98 g of formic acid (HCOOH=85% by weight) in order to reach pH 3.8. Thereafter, stirring was continued at 65° C. for another 3 hours. Finally, 159.4 g of alcohol/water mixture were removed by distillation at about 120 mbar. 24.57 g of water and 0.92 g of formic acid (HCOOH=85% by weight) were added to the mixture. The residue that had been cooled down to room temperature was filtered through a paint filter. The final weight of the residue was 661.44 g.

A milky/cloudy liquid having a pH of 4.0 was obtained.

The product is storage-stable for at least 6 months.

Dry residue: 25.8% by weight

SiO₂ content: 15.5% by weight

Free methanol: 1.1% by weight

Free ethanol: 0.5% by weight

### Example 3

A 2 l stirred apparatus with metering apparatus and reflux condenser under a nitrogen atmosphere was initially charged with 1150.7 g of water and 2.0 g of formic acid (HCOOH=85% by weight). 196 g of HP 1535 and then 210 g of GLYMO were metered in (pH after the addition=2.5) and the mixture was heated to 65° C. and stirred for 1 hour. 11.73 g of formic acid (HCOOH=85% by weight) were added, and 90 g of bis-AMEO were metered in via the metering apparatus. It was still necessary to add 2.6 g of formic acid (HCOOH=85% by weight) in order to reach pH 4.0. Thereafter, stirring was continued at 65° C. for another 3 hours. Finally, 321.52 g of alcohol/water mixture were removed by distillation at about 230 mbar. 42.85 g of water and 1.0 g of formic acid (HCOOH=85% by weight) were added to the mixture. The residue that had been cooled down to room temperature was filtered through a paint filter. The final weight of the residue was 1329.12 g.

A milky/cloudy liquid having a pH of 4.3 was obtained.

The product is storage-stable for at least 6 months.

Dry residue: 20.7% by weight

SiO₂ content: 10.7% by weight

Free methanol: 1.1% by weight

Free ethanol: 0.6% by weight

### Example 4

A 2 l stirred apparatus with metering apparatus and reflux condenser under a nitrogen atmosphere was initially charged with 758.8 g of water and 2.13 g of formic acid (HCOOH=85% by weight). 588 g of HP 1535 and then 210 g of GLYMO were metered in (pH after the addition=2.5), and the mixture was heated to 65° C. and stirred for 1 hour. 11.73 g of formic acid (HCOOH=85% by weight) were added, and 90 g of Dynasyan® 1122 were metered in via the metering apparatus. Thereafter, stirring was continued at 65° C. for another 3 hours. Finally, 306.17 g of alcohol/water mixture were removed by distillation at about 300 mbar. 25.15 g of water were added to the mixture. The residue that had been cooled down to room temperature was filtered through a paint filter.

The final weight of the residue was 1346.94 g.

A milky/cloudy liquid having a pH of 4.2 was obtained.

The product is storage-stable for at least 6 months.

Dry residue: 30.8% by weight

SiO₂ content: 20.5% by weight

Free methanol: 1.3% by weight

Free ethanol: 0.6% by weight

### Example 5

A 2 l stirred apparatus with metering apparatus and reflux condenser under a nitrogen atmosphere was initially charged with 831.9 g of water and 3.0 g of formic acid (HCOOH=85% by weight). 514.5 g of HP 5540 and then 210 g of GLYMO were metered in (pH after the addition=2.0), and the mixture was heated to 65° C. and stirred for 1 hour. 11.74 g of formic acid (HCOOH=85% by weight) were added, and 90 g of Dynasyan® 1122 were metered in via the metering apparatus. It was still necessary to add a total of 177 g of formic acid (HCOOH=85% by weight) in order to reach pH 4.0. Thereafter, stirring was continued at 65° C. for another 3 hours. Finally, 314.63 g of alcohol/water mixture were removed by distillation at about 180 mbar. 38.02 g of water were added to the mixture. The residue that had been cooled down to room temperature was filtered through a paint filter. The final weight of the residue was 1334.02 g.

A milky/cloudy liquid having a pH of 4.3 was obtained.

The product is storage-stable for at least 6 months.

Dry residue: 31.0% by weight

SiO₂ content: 20.7% by weight

Free methanol: 1.1% by weight

Free ethanol: 0.5% by weight

### Example 6

A 2 l stirred apparatus with metering apparatus and reflux condenser under a nitrogen atmosphere was initially charged with 1003.7 g of water and 3.0 g of formic acid (HCOOH=85% by weight). 343 g of HP 5540 and then 210 g of GLYMO were metered in (pH after the addition=3.0), and the mixture was heated to 65° C. and stirred for 1 hour. 11.88 g of formic acid (HCOOH=85% by weight) were added, and 90 g of bis-AMEO were metered in via the metering apparatus. It was still necessary to add 2.32 g of formic acid (HCOOH=85% by weight) in order to reach pH 4.0. Thereafter, stirring was continued at 65° C. for another 3 hours. Finally, 311.97 g of alcohol/water mixture were removed by distillation at about 200 mbar. 28.71 g of water were added to the mixture. The residue that had been cooled down to room temperature was filtered through a paint filter. The final weight of the residue was 1343.39 g.

A milky/cloudy liquid having a pH of 4.2 was obtained.

The product is storage-stable for at least 6 months.

Dry residue: 25.9% by weight

SiO₂ content: 15.7% by weight

Free methanol: 1.1% by weight

Free ethanol: 0.5% by weight

### Example 7

A 2 l stirred apparatus with metering apparatus and reflux condenser under a nitrogen atmosphere was initially charged with 1175.1 g of water and 3.0 g of formic acid (HCOOH=85% by weight). 171.5 g of HP 5540 and then 210 g of GLYMO were metered in (pH after the addition=2.0), and the mixture was heated to 65° C. and stirred for 1 hour. 11.73 g of formic acid (HCOOH=85% by weight) were added, and 90 g of bis-AMEO were metered in via the metering apparatus. It was still necessary to add 0.91 g of formic acid (HCOOH=85% by weight) in order to reach pH 4.0. Thereafter, stirring was continued at 65° C. for another 3 hours. Finally, 336.96 g of alcohol/water mixture were removed by distillation at about 190 mbar. 58.03 g of water were added to the mixture. The residue that had been cooled down to room temperature was filtered through a paint filter. The final weight of the residue was 1314.02 g.

A cloudy pale beige liquid having a pH of 5.0 was obtained.

The product is storage-stable for at least 6 months.

Dry residue: 21.2% by weight

SiO₂ content: 10.7% by weight

Free methanol: 0.9% by weight

Free ethanol: 0.5% by weight

### Example 8

A 2 l stirred apparatus with metering apparatus and reflux condenser under a nitrogen atmosphere was initially charged with 1203.89 g of water and 3.00 g of formic acid (HCOOH=85% by weight). Subsequently, 135.68 g of Koestrosol 3550 were added, and 180 g of Dynasyan® GLYMO were metered in via a metering apparatus. The mixture was heated to 65° C. and stirred at this temperature for 1 hour. 17.7 g of formic acid (HCOOH=85% by weight) were added, and 120 g of Dynasyan® 1122 were metered in via the metering apparatus. Thereafter, stirring was continued at 65° C. for 3 hours and an additional 1.11 g of formic acid (HCOOH=85% by weight) were added. Finally, 340.64 g of alcohol/water mixture were removed by distillation at about 180 mbar. 38.80 g of demineralized water were added to the mixture.

The final weight of the residue was 1347.82 g.

Another 36.19 g of alcohol/water mixture were removed by distillation from the mixture at about 180 mbar, and 51.22 g of demineralized water were added. The cooled residue was filtered through a Seitz T-950 filter plate.

The final weight of the residue was 1347.82 g.

A milky white liquid having a pH of about 4.3 was obtained.

The product is storage-stable for at least 6 months.

Dry residue: 20.6% by weight

SiO₂ content: 10.8% by weight

Free methanol: 0.4% by weight

Free ethanol: 0.7% by weight

### Example 9

A 2 l stirred apparatus with metering apparatus and reflux condenser under a nitrogen atmosphere was initially charged with 1067.61 g of water and 3.00 g of formic acid (HCOOH=85% by weight). Subsequently, 271.09 g of Koestrosol 3550 were added, and 180.16 g of GLYMO were metered in via a metering apparatus. The mixture was heated to 65° C. and stirred at this temperature for 1 hour.

After the mixture had been stirred at 65° C. for 1 hour, it was adjusted to pH 3.0 with an additional 2.79 g of formic acid (HCOOH=85% by weight) and stirred at 65° C. for another 0.5 hour. Subsequently, 17.71 g of formic acid (HCOOH=85% by weight) were added, and 120.06 g of Dynasyan® 1122 were metered in. Thereafter, stirring of the mixture was continued at 65° C. for 3 hours and another 3.21 g of formic acid (HCOOH=85% by weight) were added. Finally, 343.80 g of alcohol/water mixture were removed by distillation at about 160 mbar. 48.91 g of demineralized water were added to the mixture.

The cooled residue was filtered through a Seitz T-950 filter plate.

The final weight of the residue was 1308.51 g.

A milky white liquid having a pH of about 4.0 was obtained.

The product is storage-stable for at least 6 months.

Dry residue: 26.0% by weight

SiO₂ content: 15.8% by weight

Free methanol: 1.0% by weight

Free ethanol: 0.5% by weight

### Example 10

A 2 l stirred apparatus with metering apparatus and reflux condenser under a nitrogen atmosphere was initially charged with 1112.88 g of water and 101 g of formic acid (HCOOH=85% by weight). First 225.49 g of Koestrosol K 1530 (pH after the addition=3.5), then 180 g of GLYMO were metered in, the mixture was heated to 65° C. and the mixture was stirred for 1 hour. Subsequently, 18.71 g of formic acid (HCOOH=85% by weight) were added, and 120 g of bis-AMEO were metered in via the metering apparatus. At a pH of 4.0, the mixture was stirred at 65° C. for 3 hours. Finally, 321.56 g of alcohol/water mixture were removed by distillation at about 130 mbar. 20.23 g of water were added to the mixture. The residue was cooled to RT, then filtered through a Seitz T-950 filter plate. The final weight of the residue was 1334.77 g.

A liquid having a pH of 4.0 was obtained. The product is storage-stable for at least 6 months.

Dry residue: 20.9% by weight

SiO₂ content: 10.5% by weight

Free methanol: 1.2% by weight

Free ethanol: 0.8% by weight

### Example 11

A 2 l stirred apparatus with metering apparatus and reflux condenser under a nitrogen atmosphere was initially charged with 1265.70 g of water and 3.05 g of formic acid (HCOOH=85% by weight). First 133.43 g of Koestrosol 3550 (pH after the addition=3.0), then 134.93 g of GLYMO were metered in, the mixture was heated to 65° C. and the mixture was stirred for 1 hour. 21.08 g of formic acid (HCOOH=85% by weight) were added, and 119.97 g of bis-AMEO were metered in via the metering apparatus. After stirring for 15 minutes, 44.99 g of PTMO were added. At a pH of 3.9, the mixture was stirred at 65° C. for 3 hours. Finally, 370.09 g of alcohol/water mixture were removed by distillation at about 130 mbar. 32.57 g of water were added to the mixture. The residue was cooled to RT, then filtered through a Seitz K-900 tilter plate. The final weight of the residue was 1340.09 g.

A milky/cloudy liquid having a pH of 3.9 was obtained. The product is storage-stable for at least 6 months.

Dry residue: 19.8% by weight

SiO₂ content: 11.0% by weight

Free methanol: 1.3% by weight

Free ethanol: 1.1% by weight

### Example 12

To an initial charge of 1267.5 g of water in a 21 stirred apparatus with metering apparatus and reflux condenser were added 3.0 g of HCOOH (85%). 271.0 g of Koestrosol 3550 were added dropwise within 10 minutes. Subsequently, 180 g of GLYMO were metered in within 10 minutes via the metering apparatus. The mixture was stirred at 65° C. for 1 h. Subsequently, 17.7 g of HCOOH (85%) were added and 120 g of Dynasylan® 1127 were metered in within 10 minutes. The mixture was stirred at 65° C. for 3 h.

The pH was between 3.3 and 3.9. It was to be measured before and after each addition. Within the 3 h, the pH was to be checked at regular intervals.

Thereafter, about 302 g of alcohol/water mixture were distilled off at about 130-200 mbar. It was observed here whether the mixture was viscous and, if it was, the distillation was stopped. The final weight of the residue was 1558 g; demineralized water and/or acid can be added if necessary; note pH.

The product was filtered at room temperature through a Seitz T-950 filter plate.

Dry residue: 22.0% by weight

SiO₂: 13.4% by weight

Free MeOH: 0.7% by weight

Free EtOH: 0.4% by weight

### Example 13

To an initial charge of 1067.5 g of water in a 2 l stirred apparatus with metering apparatus and reflux condenser were added 2.0 g of H₃PO₄ (85%), and the mixture was then mixed rapidly with 271.0 g of Koestrosol 3550 while stirring. The metering apparatus was used to meter in 165 g of GLYMO within 10 minutes. The mixture was stirred at 65° C. for 1 h. Subsequently, 33.0 g of H₃PO₄ (85%) were added and 135 g of Dynasylan® 1122 were metered in within 10 minutes. The mixture was stirred at 65° C. for 3 h.

The pH was between 3.3 and 3.9. It was to be measured before and after each addition. Within the 3 h, the pH was to be checked at regular intervals.

Thereafter, about 302 g of alcohol/water mixture were distilled off. It was observed here whether the mixture was viscous and, if it was, the distillation was stopped.

The final weight of the residue was 1355 g; demineralized water or aqueous acid can be added if necessary; note pH.

The product was filtered at room temperature through a Seitz T-900 filter plate.

Dry residue: 25.4% by weight

SiO₂: 15.8% by weight

Free MeOH: 0.7% by weight

Free EtOH: 0.5% by weight

### Example 14

To an initial charge of 887.6 g of water in a 2 l stirred apparatus with metering apparatus and reflux condenser was added 1.0 g of HNO₃ (65%). 227.9 g of Koestrosol 3550 were added dropwise within 10 minutes. Subsequently, 150 g of GLYMO were metered in within 10 minutes via the metering apparatus. The mixture was stirred at 65° C. for 1 h. Subsequently, 44.7 g of HNO₃ (65%) were added and 100 g of Dynasyan® 1127 were metered in within 10 minutes. The mixture was stirred at 65° C. for 3 h.

The pH was between 3.3 and 3.9. It was to be measured before and after each addition. Within the 3 h, the pH was to be checked at regular intervals.

Thereafter, about 252 g of alcohol/water mixture were distilled off at about 130-200 mbar. It was observed here whether the mixture was viscous and, if it was, the distillation was stopped. The final weight of the residue was 1139.5 g; water and acid were added if necessary and the pH was measured.

The product was filtered at room temperature through a Seitz T-950 filter plate.

Dry residue: 22.8% by weight

SiO₂: 15.6% by weight

Free MeOH: 0.8% by weight

Free EtOH: 0.4% by weight

Production of the Compositions (BMF) for Storage Tests

Additions used for the application examples:
4P/16 zinc powder (Everzinc, Belgium)
MIOX MICRO 30 (Kaminer Montanindustrie)
Bayferrox Red 130 BM (Harald-Scholz Co. & GmbH)
Red Seal zinc oxide (Everzinc, Belgium)
M500 crystalline silica dust (SIBELCO)
MKT mica (Imerys Ceramics, France)
RDI-S titanium dioxide (Huntsman)
talc (Talc Extra Blanco, Minerals l Derivats S.A. Spain)

The additions in question were incorporated into a formulation from the preceding examples with a Dispermat CA 40 DSC. The viscosities were determined with a 4 mm flow cup according to DIN.

Table 1 shows the compositions (BMF) for storage tests. For production of the compositions BMF2 to 34, proceeding from the formulation from the examples in question, particulate substances FS1 to FS8 were incorporated by dispersion with addition of water.

(FS1=MIOX Micro 30, FS2=MKT MICA, FS3=Sibelco, FS4=Bayferrox Red BM 130, FS5=zinc oxide, FS6=titanium dioxide, FS7=Talc Extra Blanco, FS8=4P/16 zinc powder)

| | | | Ad- | | | | | | | | |
|---|---|---|---|---|---|---|---|---|---|---|---|
| | | | dition | | | | | | | | |
| | | Pro- | of water | | | | | | | | |
| | | portion | to the | | | | | | | | |
| | | of the | formu- | | | | | | | | |
| | | formu- | lation | | | | | | | | |
| | | lation | in % | FS1 in | FS2 in | FS3 in | FS4 in | FS5 in | FS6 in | FS7 in | FS8 in |
| | | in the | by wt., | % by wt., | % by wt., | % by wt., | % by wt., | % by wt., | % by wt., | % by wt., | % by wt., |
| | Formu- | com- | based | based | based | based | based | based | based | based | based |
| | lation | position | on the | on the | on the | on the | on the | on the | on the | on the | on the |
| | from | in % by | com- | com- | com- | com- | com- | com- | com- | com- | com- |
| | example | weight | position | position | position | position | position | position | position | position | position |
| BMF1 | 12 | 100 | — | — | — | — | — | — | — | — | — |
| BMF2 | 12 | 90 | 10 | — | — | — | — | — | — | — | — |
| BMF3 | 12 | 69.5 | 23 | — | — | — | — | 7.5 | — | — | — |
| BMF4 | 12 | 60 | 20 | — | — | — | — | 20 | — | — | — |
| BMF5 | 12 | 56 | 7 | — | 37 | — | — | — | — | — | — |
| BMF6 | 12 | 47 | 6 | — | 47 | — | — | — | — | — | — |
| BMF7 | 12 | 56 | 7 | 37 | — | — | — | — | — | — | — |
| BMF8 | 12 | 47 | 6 | 47 | — | — | — | — | — | — | — |
| BMF9 | 12 | 56 | 7 | — | — | 37 | — | — | — | — | — |
| BMF10 | 12 | 47 | 6 | — | — | 47 | — | — | — | — | — |
| BMF11 | 12 | 56 | 7 | — | — | — | — | — | 37 | — | — |
| BMF12 | 12 | 47 | 6 | — | — | — | — | — | 47 | — | — |
| BMF13 | 12 | 70 | 23 | — | — | — | — | 7 | — | — | — |
| BMF14 | 12 | 60 | 20 | — | — | — | — | 20 | — | — | — |
| BMF15 | 12 | 50 | 17 | — | 33 | — | — | — | — | — | — |
| BMF16 | 12 | 43 | 14 | — | 43 | — | — | — | — | — | — |
| BMF17 | 12 | 50 | 17 | 33 | — | — | — | — | — | — | — |
| BMF18 | 12 | 43 | 14 | 43 | — | — | — | — | — | — | — |
| BMF19 | 12 | 50 | 17 | — | — | 33 | — | — | — | — | — |
| BMF20 | 12 | 43 | 14 | — | — | 43 | — | — | — | — | — |
| BMF21 | 12 | 56 | 7 | — | — | — | — | — | 33 | — | — |
| BMF22 | 12 | 47 | 6 | — | — | — | — | — | 43 | — | — |
| BMF23 | 12 | 50 | — | 18.8 | 18.8 | — | — | 12.4 | — | — | — |
| BMF24 | 12 | 47 | 6 | 25 | — | — | 22 | — | — | — | — |
| BMF25 | 12 | 50 | 17 | 20 | — | — | 13 | — | — | — | — |
| BMF26 | 12 | 43 | 14 | 25 | — | — | 18 | — | — | — | — |
| BMF27 | 12 | 56 | 7 | 20 | — | — | — | — | 17 | — | — |
| BMF28 | 12 | 47 | 6 | 25 | — | — | — | — | 22 | — | — |
| BMF29 | 12 | 32.8 | — | 50 | — | — | — | 17.2 | — | — | — |
| BMF30 | 12 | 42.4 | 11.3 | — | 22.3 | — | — | 24.0 | — | — | — |
| BMF31 | 12 | 56.4 | — | — | 11 | 10.6 | 5.5 | 11 | — | 5.5 | — |
| BMF32 | 12 | 47 | 6 | 25 | — | — | — | — | — | 22 | — |
| BMF33 | 12 | 51.0 | 14 | 25.5 | | | | 9.5 | | | — |
| BMF34 | 12 | 62 | — | — | — | — | — | — | — | — | 38 |

Table 2 shows the pH values and the viscosities of the BMFs at the start and after storage at 50° C. for 4 months.

| | Before heat storage | | After heat storage at 50° C. for 4 months | | |
|---|---|---|---|---|---|
| | | Viscosity | | Viscosity | |
| | | DIN 4 | | DIN 4 | |
| | pH | mm/sec | pH | mm/sec | Appearance after storage |
| BMF1 | 3.3 | 11 | 3.3 | 11 | no change |
| BMF2 | 3.4 | 12 | 3.2 | 12 | no change |
| BMF3 | 6.0 | 22 | 6.2 | 21 | sediment which can easily be stirred up again |
| BMF4 | 6.1 | 24 | 6.0 | 24 | sediment which can easily be stirred up again |
| BMF5 | 3.4 | 30 | 3.3 | 29 | sediment which can easily be stirred up again |
| BMF6 | 3.4 | 120 | 3.4 | 120 | sediment which can easily be stirred up again |
| BMF7 | 6.3 | 17 | 6.2 | 16 | sediment which can easily be stirred up again |
| BMF8 | 6.5 | 18 | 6.7 | 19 | sediment which can easily be stirred up again |
| BMF9 | 3.1 | 19 | 3.0 | 19 | sediment which can easily be stirred up again |
| BMF10 | 3.3 | 21 | 3.2 | 22 | sediment which can easily be stirred up again |
| BMF11 | 3.4 | 25 | 3.4 | 26 | sediment which can easily be stirred up again |
| BMF12 | 3.2 | 28 | 3.2 | 28 | sediment which can easily be stirred up again |
| BMF13 | 6.1 | 18 | 6.0 | 18 | sediment which can easily be stirred up again |
| BMF14 | 6.1 | 20 | 6.2 | 20 | sediment which can easily be stirred up again |
| BMF15 | 3.2 | 30 | 3.1 | 31 | sediment which can easily be stirred up again |
| BMF16 | 3.1 | 64 | 3.0 | 60 | sediment which can easily be stirred up again |
| BMF17 | 6.3 | 14 | 6.2 | 14 | sediment which can easily be stirred up again |
| BMF18 | 6.3 | 15 | 6.3 | 16 | sediment which can easily be stirred up again |
| BMF19 | 3.2 | 14 | 3.2 | 14 | sediment which can easily be stirred up again |
| BMF20 | 3.4 | 16 | 3.4 | 16 | sediment which can easily be stirred up again |
| BMF21 | 3.2 | 20 | 3.3 | 19 | sediment which can easily be stirred up again |
| BMF22 | 3.3 | 22 | 3.1 | 22 | sediment which can easily be stirred up again |
| BMF23 | 6.1 | 16 | 6.1 | 16 | sediment which can easily be stirred up again |
| BMF24 | 6.2 | 18 | 6.3 | 18 | sediment which can easily be stirred up again |
| BMF25 | 6.1 | 14 | 6.1 | 15 | sediment which can easily be stirred up again |
| BMF26 | 6.0 | 17 | 6.2 | 18 | sediment which can easily be stirred up again |
| BMF27 | 6.0 | 18 | 6.1 | 18 | sediment which can easily be stirred up again |
| BMF28 | 6.1 | 20 | 6.1 | 20 | sediment which can easily be stirred up again |
| BMF29 | 6.1 | 15 | 6.1 | 15 | sediment which can easily be stirred up again |
| BMF30 | 6.0 | 17 | 6.2 | 18 | sediment which can easily be stirred up again |
| BMF31 | 6.3 | 21 | 6.1 | 22 | sediment which can easily be stirred up again |
| BMF32 | 6.2 | 24 | 6.1 | 24 | sediment which can easily be stirred up again |
| BMF33 | 5.9 | 16 | 6.1 | 14 | sediment which can easily be stirred up again |
| BMF34 | 7.3 | 18 | — | — | gelated/hardened after one day |

As can be infeed from Table 2, all inventive compostions BMF2 to BMF33 are stable after storage at 50° C. over 4 months (virtually no change in pH and viscosity) provided that the pH of the binder formulation is <7. Should the pH of a binder formulation rise to >6.5 as a result of the addition of said particulate substances (FS1 to FS7), it can be adjusted to <6.6 with one of the said acids. BMF 34 shows the catalytic effect of zinc dust for the hardening of the system.

Comparative examples from WO 2012/130544 with regard to storage stability of binder for the formulation of zinc dust paints; cf. tables 2a to 2e (figures for the formulation each in % by weight, based on the composition):

TABLE 2a
Use example 5 from WO 2012/130544:

| | Composition in | With | |
|---|---|---|---|
| | Example 5 | itemized | 100% |
| | WO 2012/130544 | fillers | formulation |
| Binder 6 | 4.0 | 4.0 | 28.6 |
| (from Example 30) | | | |
| Addition consisting of: | 10.0 | | |
| mixture B | 75.0% | | |
| mixture M | 25.0% | | 0 |
| Zinc oxide | | 0.9045 | 6.5 |
| Bayferrox 130 BM | | 0.906 | 6.5 |
| MIOX Micro 30 | | 2.6895 | 19.2 |
| Zinc dust | | 3.0 | 21.4 |
| Sikron M500 | | 2.5 | 17.8 |

TABLE 2b
Modified use example 5 from WO 2012/130544, no zinc dust:

| | Composition in | | |
|---|---|---|---|
| | Example 5 | With | |
| | WO 012/130544, | itemized | 100% |
| | no zinc dust | fillers | formulation |
| Binder 6 | 4.0 | 4.0 | 33.3 |
| (from Example 30) | | | |
| Addition consisting of: | 8.0 | | |
| mixture B (no Zn) | 75% | | |
| mixture M | 25% | | 0 |
| Zinc oxide | | 1.206 | 10.1 |
| Bayferrox 130 BM | | 1.206 | 10.1 |
| MIOX Micro 30 | | 3.588 | 29.9 |
| Zinc dust | | | 0 |
| Sikron M500 | | 2.0 | 16.6 |

TABLE 2c
Use example 7 from WO 2012/130544:

| | Composition in | With | |
|---|---|---|---|
| | Example 7 | itemized | 100% |
| | WO 2012/130544 | fillers | formulation |
| Binder 8 | 4.0 | 4.0 | 28.6 |
| (from Example 35) | | | |
| Addition consisting of: | 10.0 | | |
| mixture B | 75.0% | | |
| mixture M | 25.0% | | 0 |
| Zinc oxide | | 0.9045 | 6.5 |
| Bayferrox 130 BM | | 0.906 | 6.5 |
| MIOX Micro 30 | | 2.6895 | 19.2 |
| Zinc dust | | 3.0 | 21.4 |
| Sikron M500 | | 2.5 | 17.8 |

TABLE 2d
Modfied use example 7 from WO 2012/130544, no zinc dust:

| | Composon in | With | |
|---|---|---|---|
| | Example 7, | itemized | 100% |
| | no zinc dust | fillers | formulation |
| Binder 8 | 4.0 | 4.0 | 33.3 |
| (from Example 35) | | | |
| Addition consisting of: | 8.0 | | |
| mixture B (no Zn) | 75% | | |
| mixture M | 25% | | 0 |
| Zinc oxide | | 1.206 | 10.1 |
| Bayferrox 130 BM | | 1.206 | 10.1 |
| MIOX Micro 30 | | 3.588 | 29.9 |
| Zinc dust | | | 0 |
| Sikron M500 | | 2.0 | 16.6 |

TABLE 2e
The formulations with regard to Use Examples 5 and 7 from WO 2012/130544 were produced
without zinc and stored in order to be directly comparable with Use Examples BMF 23 and
BMF 31. The results from comparative storage tests show that binders according to the
invention for use for production or for formulation of zinc dust paints are storage-stable
for much longer periods than those according to binders from WO 2012/130544.

| | Comparative examples from WO 2012/130544 | | | | | |
|---|---|---|---|---|---|---|
| | from WO | from WO | from WO | from WO | Inventive examples | |
| | 2012/130544 | 2012/130544 | 2012/130544 | 2012/130544 | Use | Use |
| | Use Example | Use Example 5, | Use Example | Use Example 7, | Example | Example |
| | 5 | no zinc | 7 | no zinc | BMF 23 | BMF 31 |
| Binder 6 (from | 28.6 | 33.3 | | | | |
| Example 30) | | | | | | |
| Binder 8 (from | | | 28.6 | 33.3 | | |
| Example 35) | | | | | | |
| Binder for zinc | | | | | 50 | 56.4 |
| dust paints | | | | | | |
| Zinc oxide | 6.5 | 10.1 | 6.5 | 10.1 | 12.4 | 11 |
| Bayferrox 130 | 6.5 | 10.1 | 6.5 | 10.1 | | 5.5 |
| BM | | | | | | |
| MIOX Micro | 19.2 | 29.9 | 19.2 | 29.9 | 18.8 | |
| 30 | | | | | | |
| Zinc dust | 21.4 | 0 | 21.4 | 0 | | |
| Sikron M500 | 17.8 | 16.6 | 17.8 | 16.6 | | 10.6 |
| Mica MKT | | | | | 18.8 | 11 |
| Talc | | | | | | 5.5 |
| Storage stability | 1 (solid) | 3 (solid) | 1 (solid) | 3 (solid) | >120 | >120 |
| at 50° C. in days | | | | | | |

Performance Testing of the Stored BMFs

TABLE 3
For the application examples (EF1 to EF10),
the following BMFs were used:

| | | Proportion | Proportion by |
|---|---|---|---|
| | | by weight of | weight of 4/P16 |
| | BMFs | BMF in the | zinc powder in |
| Application | used; cf. | application | the application |
| formulation | Tables 2 | formulation | formulation |
| EF 1 | BMF1 | 16 | 84 |
| EF 2 | BMF3 | 72.1 | 27.9 |
| EF 3 | BMF4 | 72.0 | 28.0 |
| EF 4 | BMF17 | 72.2 | 27.8 |
| EF 5 | BMF18 | 72.2 | 27.8 |
| EF 6 | BMF33 | 32 | 68 |
| EF 7 | BMF31 | 67.8 | 32.8 |
| EF 8 | BMF23 | 64 | 36 |
| EF 9 | BMF29 | 70 | 30 |
| EF 10 | BMF30 | 36 | 64 |

The application formulations listed in Table 3 were applied to steel sheets.

Cleaning of the R-36 Steel Test Sheets Made from DC01 C290, 152×76×0.8 mm (Rocholl)

The steel test sheets were placed into an alkaline cleaning bath (composition: 10.0 g/I S 5610, pH 11.5, 60° C., 35 sec.). After the alkaline cleaning, the metal substrates were rinsed with demineralized water. The excess water was blown off the surface with a compressed air gun.
Application: Spiral applicator wet film thickness 60 μm
Dry film thickness: 20-30 μm
Cross-cut: to EN ISO 2409
Corrosion test: Neutral salt spray test (NSS) according to DIN EN ISO 9227
Abrasion resistance: Scrub test with SDL Atlas M238BB Electronic Crockmeter, contact with water for 15 sec, followed by 10 back-and-forth strokes with Wypai X60 from Kimberly Clark, assessment: 10=no change, 0=coating rubbed off completely

The Zn-containing application formulations produced according to Table 3, ater the coating operation, were dried/hardened at 20° C. for 24 hours and tested.

The test results are compiled in Table 4.

| | | | | Results with BMFs which had | | |
|---|---|---|---|---|---|---|
| Appli- | Results without prior storage | | | been stored beforehand at | | |
| cation | of the BMFs used | | | 50° C. for 4 months | | |
| formu- | Scrub | Cross- | | Scrub | Cross- | |
| lation | test | cut | NSS | test | cut | NSS |
| EF 1 | 5 | CC0 | corrosion over the | 4 | CC0 | corrosion over the |
| | | | entire area after 80 | | | entire area after 80 |
| | | | hours | | | hours |
| EF 2 | 6 | CC1 | corrosion over the | 6 | CC1 | corrosion over the |
| | | | entire area after 150 | | | entire area after 250 |
| | | | hours | | | hours |
| EF 3 | 6 | CC1 | corrosion over the | 7 | CC1 | corrosion over the |
| | | | entire area after 150 | | | entire area after 150 |
| | | | hours | | | hours |
| EF 4 | 6 | CC1 | corrosion over the | 7 | CC1 | corrosion over the |
| | | | entire area after 200 | | | entire area after 250 |
| | | | hours | | | hours |
| EF 5 | 6 | CC1 | corrosion over the | 7 | CC1 | corrosion over the |
| | | | entire area after 200 | | | entire area after 250 |
| | | | hours | | | hours |
| EF 6 | 5 | CC1 | slight corrosion over | 5 | CC1 | slight corrosion over |
| | | | the area after 500 | | | the area after 500 |
| | | | hours | | | hours |
| EF 7 | 8 | CC1 | corrosion over the | 7 | CC1 | corrosion over the |
| | | | entire area after 300 | | | entire area after 300 |
| | | | hours | | | hours |
| EF 8 | 10 | CC1 | corrosion over the | 9 | CC1 | corrosion over the |
| | | | entire area after 300 | | | entire area after 300 |
| | | | hours | | | hours |
| EF 9 | 9 | CC1 | corrosion over the | 9 | CC1 | corrosion over the |
| | | | entire area after 350 | | | entire area after 350 |
| | | | hours | | | hours |
| EF 10 | 8 | CC1 | slight corrosion over | 9 | CC1 | slight corrosion over |
| | | | the area after 500 | | | the area after 500 |
| | | | hours | | | hours |

As can be inferred from Table 4, the performance results before and after storage are identical. This shows that the compositions according to the invention can be utilized advantageously without any problems as storage-stable aqueous systems, or precursors for zinc dust paints, that can be handled advantageously.

1: An aqueous sol-gel composition as a storage-stable, solvent-free precursor for zinc dust paints, based on the reaction of at least following components:
(i) a glycidyloxypropylalkoxysilane of the formula (I)
X—Si(OR)₃ (I)
in which X is a 3-glycidyloxypropyl group and R is a methyl or ethyl group,
(ii) an aqueous silica sol having an average particle size of 5 to 150 nm and a solids content of ≥20% to ≤60% by weight,
(iii) at least one acid selected from the group consisting of nitric acid, sulfuric acid, hydrochloric acid, phosphoric acid, formic acid, and acetic acid,
(iv) a bisaminoalkoxysilane of the formula (II)
(R¹O)₃Si(CH₂)₃(NH)(CH₂)₃Si(OR¹)₃ (II)
in which R¹ represents a methyl or ethyl group, and
optionally, (v) at least one further alkoxysilane of the formula (III)
Yₙ—Si(OR³)₄₋ₙ (III)
in which Y represents a propyl, butyl, octyl, 3-mercaptopropyl, 3-ureidopropyl or 3-isocyanatopropyl group, R³ is a methyl or ethyl group and n is 0 or 1,
wherein an initial mass ratio of component (ii) to component (i) of 0.55 to 0.75 and an initial mass ratio of component (ii) to component (iv) of 0.35 to 0.55 are used,
and containing
(vi) at least one particulate filler selected from the group consisting of precipitated silica, fumed silica, crystalline silica, kaolin, feldspar, talc, zinc oxide, iron(III) oxide, aluminum oxide, and titanium dioxide, having a content of 5% to 70% by weight, based on the composition,
wherein the aqueous sol-gel composition has a content of alcohol of <3% by weight, based on the overall composition, and a pH of 3.0 to 6.5.

2: The composition according to claim 1, wherein the mass ratio of component (ii) to component (i) is 0.60 to 0.70 and mass ratio of component (ii) to component (iv) is 0.40 to 0.50.

3: The composition according to claim 1, wherein the aqueous silica sol as component (ii) has a pH of 8.5 to 10.5.

4: The composition according to claim 1, wherein the aqueous silica sol as component (ii) comprises amorphous silica particles having an average diameter of ≥5 to 150 nm.

5: The composition according to claim 1, wherein a content of methanol and/or ethanol is of <3% by weight, based on the overall composition.

6: The composition according to claim 5, wherein the content of methanol and/or ethanol is of 0.5% to 2.5% by weight, based on the overall composition.

7: A process for producing the aqueous sol-gel composition according to claim 1, comprising:
initially charging water and the acid as per component (iii),
under an inert gas atmosphere and while stirring, metering in the aqueous silica sol as per component (ii) and then the glycidyloxypropylalkoxysilane of the formula (I) as per component (i), heating while stirring, and
subsequently metering in the bisaminoalkoxysilane of the formula (II) as per component (iv), and once or more than once metering in the acid as per component (iii) and optionally metering in the at least one further alkoxysilane of the formula (III) as per component (v) while stirring, allowing reaction to continue for a further period,
then removing an alcohol of hydrolysis that has formed thereof by distillation, optionally adding water, cooling to room temperature and then filtering a reaction product thus obtained and stirring the at least one particulate filler as per component (vi) into a filtrate thus obtained, and
optionally establishing a pH of 3.0 to 6.5 with addition of the acid as per component (iii).

8: The process according to claim 7, wherein the metering in of components (ii) and (i) is followed by stirring over a period of 30 to 90 minutes and heating to a temperature in the range from 50 to 70° C.

9: The process according to claim 7,
wherein the metering in of components (iv) and optionally (v) is followed by stirring over a period of 30 to 300 minutes and the reaction is continued at a temperature in the range from 50 to 70° C.

10: The process according to claim 7, wherein the alcohol of hydrolysis formed in the reaction, methanol and/or ethanol are removed under reduced pressure and wherein the amount of alcohol removed is optionally replaced by a corresponding amount of water.

11: The process according to claim 7, wherein the reaction product is cooled to room temperature and then filtered through a paint filter.

12: The process according to claim 7,
wherein at least one particulate filler, selected from the group consisting of precipitated silica, fumed silica, crystalline silica, kaolin, feldspar, talc, zinc oxide, iron(III) oxide, aluminum oxide, and titanium dioxide, is dispersed into said reaction product or into the filtrate and establishes a filler content of 5% to 70% by weight, based on the composition.

13: An aqueous sol-gel composition obtainable according to claim 7.

14: A method of producing an anticorrosion composition or an additive in anticorrosion compositions, varnishes, or paints, the method comprising:
dispersing zinc particles into the aqueous, storage-stable sol-gel composition according to claim 1,
wherein the zinc particles have an average particle size of 3 μm to 90 μm and serve as catalyst for hardening of the dispersion.

15: A method of producing zinc dust paint, comprising:
adding zinc powder to the aqueous sol-gel composition according to claim 1.

16: A method of formulation of zinc dust paint, the method comprising:
adding zinc powder, and zinc chloride and/or magnesium chloride to the aqueous sol-gel composition according to claim 1 and.

17: The composition according to claim 4,
wherein the amorphous silica particles present therein have an average diameter of 15 nm to 80 nm.
